(19) United States
(12) Patent Application Publication
(10) Pub. No.: US 2019/0119608 A1
(43) Pub. Date: Apr. 25, 2019

(54) SOLID PERFUME-CONTAINING COMPOSITION

(71) Applicant: Henkel AG & Co. KGaA, Duesseldorf (DE)

(72) Inventors: Peter Schmiedel, Duesseldorf (DE); Danilo Panzica, Duesseldorf (DE); Ann-Kathrin Sonnenschein, Niedenstein (DE); Bernd Larson, Erkelenz (DE); Thomas Holderbaum, Hilden (DE); Luca Bellomi, Duesseldorf (DE); Dieter Nickel, Pulheim (DE); Regina Stehr, Neuss (DE)

(73) Assignee: Henkel AG & Co. KGaA, Duesseldorf (DE)

(21) Appl. No.: 16/162,640

(22) Filed: Oct. 17, 2018

(30) Foreign Application Priority Data
Oct. 24, 2017 (DE) 102017218983.5

(51) Int. Cl. C11D 3/50; C11D 3/20; C11D 3/12; C11D 3/22; C11D 3/00; C11D 11/00

(52) U.S. Cl. CPC C11D 3/505; C11D 3/2075; C11D 3/124; C11D 11/0082; C11D 3/0021; C11D 11/0017; C11D 3/222

(57) ABSTRACT

A solid, particulate composition including at least one water-soluble carrier material, at least one fragrance and at least one bittern, the carrier material being an aqueous salt (hydrate) of which the water vapor partial pressure at a particular temperature in the range of from 30 to 100° C. corresponds to the H₂O partial pressure of the saturated solution of the salt such that the salt melts in the water of crystallization thereof at the temperature. In addition, the invention relates to methods for preparing the solid composition and to a washing or cleaning agent that contains the solid composition. Furthermore, the present invention also relates to the use of a washing or cleaning agent of this kind for cleaning textiles or hard surfaces and to corresponding methods for cleaning textiles or hard surfaces by using a washing or cleaning agent of this kind.

### FIELD OF THE INVENTION

The present invention relates to a solid, particulate composition comprising at least one water-soluble carrier material, at least one buffer system and at least one fragrance, the carrier material being an aqueous salt (hydrate) of which the water vapor partial pressure at a particular temperature in the range of from 30 to 100° C. corresponds to the H₂O partial pressure of the saturated solution of said salt such that the salt melts in the water of crystallization thereof at said temperature. Furthermore, the invention relates to methods for preparing the solid composition and to a washing or cleaning agent that contains the solid composition. Furthermore, the present invention also relates to the use of a washing or cleaning agent of this kind for cleaning textiles or hard surfaces and to corresponding methods for cleaning textiles or hard surfaces by using a washing or cleaning agent of this kind.

### BACKGROUND OF THE INVENTION

When washing and cleaning agents are used, the consumer aims not only to wash, clean or maintain the objects to be treated, but also wants the treated objects, such as textiles, to smell pleasant after being treated, for example after the wash. For this reason in particular, most commercially available washing and cleaning agents contain fragrances.

Fragrances in the form of fragrance particles are often either used as an integral component of a washing or cleaning agent or separately metered into the washing drum right at the start of a washing cycle. In this way, the consumer can control the fragrancing of the laundry to be washed through customized metering.

The main component of fragrance tablets of this kind known from the prior art is typically a water-soluble or at least water-dispersible carrier polymer, such as polyethylene glycol (PEG), which is used as a vehicle for the integrated fragrances and dissolves more or less entirely in the washing liquor over the course of the washing cycle so as to release the contained fragrances and optionally further components into the washing liquor. To prepare the known fragrances tablets, a melt is produced from the carrier polymer, which melt contains the remaining ingredients or to which they are then added, and the obtained melt is then transferred to a shaping method, during which said melt cools, solidifies and adopts the desired shape.

The known products have the drawback that the used polymer materials, in particular PEG, have delayed solubility, and this may lead to residue on the laundry or in the washing machine, in particular in the case of short washing cycles, a low temperature or other unfavorable conditions.

It has now been found, however, that an alternative composition that demonstrates a suitable processing range and has improved water solubility in the usual working temperature ranges can be provided by using, in a formulation for melt bodies, an aqueous salt (hydrate) as a carrier material of which the water vapor partial pressure at a particular temperature in the range of from 30 to 100° C. corresponds to the H₂O partial pressure of the saturated solution of said salt at said temperature such that the salt dissolves in the water of crystallization thereof at said temperature, which is a process that can be phenomenologically described as melting, but is in fact a dissolution process, thermodynamically speaking. The use of sodium acetate trihydrate is particularly advantageous.

Sodium acetate and the hydrate thereof, however, have the drawback that, while itself odorless, it produces a vinegary note when in contact with acid, even weak acid, because the effect of the acid drives acetic acid of the acetate. It has been shown that even the pH of human skin of approximately 5.5 is enough to leave behind a vinegary odor on the skin upon contact with the Na-acetate-based tablets; the consumer may perceive this odor as unpleasant.

One solution to this problem would be to add alkali, for example caustic soda, but in doing so the problem arises that many odorants can be damaged by excessive alkalinity, which may lead to off odors.

### BRIEF SUMMARY OF THE INVENTION

The object of the present invention was therefore to find a system which, firstly, is able to buffer the acidic protective lining on human skin and, secondly, does not damage the odorants. This object was achieved according to the invention by the sodium-acetate-based composition additionally containing a buffer system that can buffer the effect of acids.

In a first aspect, the present invention is therefore directed to a solid, particulate composition, comprising
(a) from 20 to 95 wt. %, based on the total weight of the composition, of at least one water-soluble carrier material selected from aqueous salts of which the water vapor partial pressure at a particular temperature in the range of from 30 to 100° C. corresponds to the H₂O partial pressure of the saturated solution of said salt, preferably sodium acetate trihydrate (Na(CH₃COO).3H₂O);
(b) from 0.1 to 20 wt. % of at least one fragrance;
(c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, at least one solid or filler that is different from (c), (d), (e) and (f); and
(h) optionally at least one dye.

In a second aspect, the invention is directed to a solid, particulate composition, comprising
(a) from 20 to 95 wt. %, based on the total weight of the composition, sodium acetate and/or a hydrate thereof and optionally water, with the proviso that, if sodium acetate is used, water is used in an amount which, based on the amount, would theoretically be necessary to ensure that at least 60 wt. % of the total amount of sodium acetate and the hydrates thereof is in the form sodium acetate trihydrate;
(b) from 0.1 to 20 wt. % of at least one fragrance;
(c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, at least one solid or filler that is different from (c), (d), (e) and (f); and
(h) optionally at least one dye.

In a third aspect, the invention is directed to a solid, particulate composition, comprising
(a) from 12 to 57 wt. %, based on the total weight of the composition, sodium acetate;
(b) from 0.1 to 10 wt. % of at least one fragrance;
(c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, of at least one solid or filler that is different from (c), (d), (e) and (f);
(h) optionally at least one dye; and
(i) water in an amount that is sufficient to convert at least 60 wt. %, preferably at least 70 wt. %, more preferably at least 80 wt. %, most preferably at least 100 wt. % of the sodium acetate (a) into sodium acetate trihydrate.

In a fourth aspect, the invention is directed to a solid, particulate composition, comprising
(a) from 20 to 95 wt. %, based on the total weight of the composition, sodium acetate trihydrate;
(b) from 0.1 to 10 wt. % of at least one fragrance;
(c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, of at least one solid or filler that is different from (c), (d), (e) and (f); and
(h) optionally at least one dye.

In a fifth aspect, the present invention is therefore directed to a solid, particulate composition comprising
(a) from 20 to 95 wt. %, based on the total weight of the composition, of at least one water-soluble carrier material selected from aqueous salts of which the water vapor partial pressure at a particular temperature in the range of from 30 to 100° C. corresponds to the H₂O partial pressure of the saturated solution of said salt, preferably sodium acetate trihydrate (Na(CH₃COO).3H₂O);
(b) from 0.1 to 20 wt. % of at least one fragrance;
(c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, of at least one solid or filler that is different from (c), (d), (e) and (f); and
(h) optionally at least one dye.

In a sixth aspect, the invention is directed to a solid, particulate composition comprising
(a) from 20 to 95 wt. %, based on the total weight of the composition, sodium acetate and/or a hydrate thereof and optionally water, with the proviso that, if sodium acetate is used, water is used in an amount which, based on the amount, would theoretically be necessary to ensure that at least 60 wt. % of the total amount of sodium acetate and the hydrates thereof is in the form sodium acetate trihydrate;
(b) from 0.1 to 20 wt. % of at least one fragrance;
(c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, at least one solid or filler that is different from (c), (d), (e) and (f); and
(h) optionally at least one dye.

In a seventh aspect, the invention is directed to a solid, particulate composition, comprising
(a) from 12 to 57 wt. %, based on the total weight of the composition, sodium acetate;
(b) from 0.1 to 10 wt. % of at least one fragrance;
(c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, of at least one solid or filler that is different from (c), (d), (e) and (f);
(h) optionally at least one dye; and
(i) water in an amount that is sufficient to convert at least 60 wt. %, preferably at least 70 wt. %, more preferably at least 80 wt. %, most preferably at least 100 wt. % of the sodium acetate (a) into sodium acetate trihydrate.

In an eighth aspect, the invention is directed to a solid, particulate composition, comprising
(a) from 20 to 95 wt. %, based on the total weight of the composition, sodium acetate trihydrate;
(b) from 0.1 to 10 wt. % of at least one fragrance;
(c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
(d) optionally up to 25 wt. %, preferably from 0.5 to 3 wt. %, based on the total weight of the composition, of an inorganic rheology modifier, preferably an inorganic rheology modifier from the group of pyrogenic silicas;
(e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
(f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) optionally up to 25 wt. %, based on the total weight of the composition, of at least one solid or filler that is different from (c), (d), (e) and (f); and
(h) optionally at least one dye.

In yet a further aspect, the present invention is directed to the use of the solid composition, as described herein, as a textile care agent, preferably as a fragrancing agent, for fragrancing textile fabrics.

In another aspect, the present invention is further directed to a washing or cleaning agent, comprising a solid composition, as described herein.

These and other aspects, features and advantages of the invention will become apparent to a person skilled in the art from studying the following detailed description and claims. Any feature from one aspect of the invention can be used in any other aspect of the invention. In particular, it is intended for it to be possible to carry over all preferred embodiments described herein to all aspects of the invention or to combine these embodiments therewith. This applies in particular to the first to eighth aspects of the invention as described above. Furthermore, it will readily be understood that the examples contained herein are intended to describe and illustrate but not to limit the invention and that, in particular, the invention is not limited to these examples.

Unless indicated otherwise, all percentages indicated are percentage by weight. Numerical ranges that are indicated in the format “from x to y” include the cited values. If several preferred numerical ranges are indicated in this format, it is self-evident that all ranges that result from the combination of the various endpoints are also included.

“At least one”, as used herein, refers to one or more, for example 1, 2, 3, 4, 5, 6, 7, 8, 9 or more. In particular, this information refers to the type of agent/compound and not to the absolute number of molecules. “At least one fragrance” therefore means that at least one type of fragrance is included, but that two or more different types of fragrances may also be contained.

“About” or “approximately,” as used herein in connection with a numerical value, refers to the numerical value+10%, preferably +5%. A temperature of approximately 50° C. therefore refers to 45-55° C., preferably 47.5-52.5° C.

“Water-soluble”, as used herein, refers to solubility in water at 20° C. of at least 1 g/L, preferably at least 10 g/L, more preferably at least 50 g/L.

The solid, particulate composition, as described herein, is prepared from a solution of the carrier material in the water/water of crystallization contained in the composition, the term “melt” also being used for a solution of this kind, in contrast with established usage, to describe the state in which the carrier material dissolves in the water of crystallization thereof as a result of the separation of water and thus forms a liquid. The term “melt”, as used herein, therefore describes the liquid state of the composition that is reached when the temperature is reached at which the carrier material separates water of crystallization and then dissolves in the water contained in the composition. The corresponding dispersion that contains the (solid) substances described herein in a manner dispersed in the melt of the carrier material is therefore also a subject of the invention. If reference is therefore made to the solid, particulate composition below, the corresponding melt/melt dispersion from which said composition can be obtained is always also included. Since said melt does not differ from the composition, except in terms of the state of matter, the terms are used synonymously herein.

The term “melt body” is used herein to describe the solid particles than can be obtained from the liquid composition through solidification/shaping when it is cooled.

The main component of the particulate, solid composition described herein is at least one water-soluble carrier material. The at least one carrier material is distinguished in that it is selected from selected from aqueous salts of which the water vapor partial pressure at a temperature in the range of from 30 to 100° C. corresponds to the H₂O partial pressure of the saturated solution of said salt at said temperature. This leads to the corresponding aqueous salt, also referred to herein as a “hydrate,” dissolving in the water of crystallization thereof when said temperature is reached or exceeded and thus transitioning from a solid to a liquid state of matter. The carrier materials according to the invention preferably demonstrate this behavior at a temperature in the range of from 40 to 90° C., particularly preferably between 50 and 85° C., more preferably between 55 and 80° C.

The above-described water-soluble carrier materials from the group of aqueous salts include in particular sodium acetate trihydrate (Na(CH₃COO).3H₂O), sodium sulfate (Na₂SO₄.10H₂O), trisodium phosphate dodecahydrate (Na₃PO₄.12H₂O) and strontium chloride hexahydrate (SrCl₂.6H₂O). Since the problem addressed by the invention arises in particular when sodium acetate is used, the use thereof of the use of the hydrates thereof is particularly preferred according to the invention.

A particularly suitable hydrate is sodium acetate trihydrate (Na(CH₃COO).3H₂O) because it dissolves in the water of crystallization thereof in the particularly preferred temperature range of from 55 to 80° C., specifically at approximately 58° C. Sodium acetate trihydrate can be used directly as such, but it is alternatively also possible to use water-free sodium acetate in combination with free water, the trihydrate then forming in situ. In embodiments of this kind, the water is used in a substoichiometric or hyperstoichiometric amount based on the amount that is necessary to convert all of the sodium acetate into sodium acetate trihydrate, preferably in an amount of at least 60 wt. %, preferably at least 70 wt. %, more preferably at least 80 wt. %, most preferably 90 wt. %, 100 wt. % or more, which is the amount that is theoretically necessary to convert all of the sodium acetate into sodium acetate trihydrate (Na(CH₃COO).3H₂O). The hyperstoichiometric use of water is particularly preferred. Based on the compositions according to the invention, this means that, if (water-free) sodium acetate is used in isolation or in combination with a hydrate thereof, the trihydrate, water is also used, the amount of water corresponding to at least the amount that would be stoichiometrically necessary to ensure that at least 60 wt. % of the total amount of sodium acetate and the hydrates thereof, preferably 70 wt. %, more preferably at least 80 wt. %, even more preferably at least 90 wt. %, most preferably at least 100 wt. %, is in the form of sodium acetate trihydrate. As has already been described above, it is particularly preferred for the amount of water to exceed the amount that would be theoretically necessary to convert all of the sodium acetate into the corresponding trihydrate. This means, for example, that a composition that contains 50 wt. % water-free sodium acetate and no hydrate thereof contains at least 19.8 wt. % water (60% of 33 wt. % that would be theoretically necessary to convert all of the sodium acetate into the trihydrate).

### DETAILED DESCRIPTION OF THE INVENTION

All the embodiments described below can be expressly combined with both of the above-mentioned alternatives.

In various embodiments, the at least one carrier material is used in such an amount that the resultant melt body, i.e. the fragrance tablet, contains from 30 to 95 wt. %, preferably from 40 to 90 wt. %, for example from 45 to 90 wt. %, based on the total weight of the melt body, of the carrier material.

A further component of the particulate solid composition described herein is at least one fragrance. A fragrance is a chemical substance that stimulates the sense of smell. To be able to stimulate the sense of smell, it should be possible for the chemical substance to be distributed in the air at least in part, i.e. the fragrance should be volatile at 25° C., at least to a small degree. If the fragrance were very volatile, the intensity of the odor would wear off quickly. At a lower volatility, however, the sensation of odor is longer-lasting, i.e. it does not disappear as quickly. In one embodiment, the fragrance therefore has a melting point that is in the range of from −100° C. to 100° C., preferably from −80° C. to 80° C., more preferably from −20° C. to 50° C., in particular from −30° C. to 20° C. In a further embodiment, the fragrance has a melting point that is in the range of from 25° C. to 400° C., preferably from 50° C. to 380° C., more preferably from 75° C. to 350° C., in particular from 100° C. to 330° C.

Overall, a chemical substance should not exceed a particular molecular mass in order to act as a fragrance; this is because it is no longer possible to ensure the necessary volatility at too high a molecular mass. In one embodiment, the fragrance has a molecular mass of from 40 to 700 g/mol, more preferably from 60 to 400 g/mol.

The odor of a fragrance is perceived by most people as pleasant and often corresponds to the odor of, for example, blossom, fruit, spices, peel, resin, leaves, grass, moss and roots. Fragrances can thus also be used to mask unpleasant odors or also to provide an odorless substance with a desired odor. It is possible to use individual odorant compounds, such as synthetic products of the ester, ether, aldehyde, ketone, alcohol and hydrocarbon types, as fragrances.

Fragrance compounds of the aldehyde type are, for example, adoxal (2,6,10-trimethyl-9-undecenal), anisaldehyde (4-methoxybenzaldehyde), cymal (3-(4-isopropylphenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, alpha-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-trimethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-alpha, alpha-dimethylhydrocinnamaldehyde, alpha-methyl-3,4-(methylenedioxy)hydrocinnamaldehyde, 3,4-methylenedioxybenzaldehyde, alpha-n-hexylcinnamaldehyde, m-cymene-7-carboxaldehyde, alpha-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, alpha-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

Fragrance compounds of the ketone type are, for example, methyl beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyl dihydrojasmonate, menthone, carvone, camphor, koavone (3,4,5,6,6-pentamethylhept-3-en-2-one), fenchone, alpha-ionone, beta-ionone, gamma-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl beta-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

Fragrance compounds of the alcohol type are, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, a-methylbenzyl alcohol, a-terpineol, amyl salicylate, benzyl alcohol, benzyl salicylate, B-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

Fragrance compounds of the ester type are, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

The ethers include, for example, benzyl ethyl ether and ambroxan. The hydrocarbons include mainly terpenes, such as limonene and pinene.

Mixtures of various fragrances which together produce an appealing fragrance note are preferably used. A mixture of fragrance of this kind may also be referred to as a perfume or perfume oil. Perfume oils of this kind may also contain natural fragrance mixtures, as are obtainable from plant sources.

The fragrances of plant origin include essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, alpha-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl beta-naphthyl ketone, methyl n-nonyl acetaldehyde, methyl n-nonyl ketone, muscone, beta-naphthol ethyl ether, beta-naphthol methyl ether, nerol, n-nonyl aldehyde, nonyl alcohol, n-octyl aldehyde, p-oxy-acetophenone, pentadecanolide, beta-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, gamma-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In one embodiment, it may be preferred for at least some of the fragrance to be used as a fragrance precursor or in encapsulated form (fragrance capsules), in particular microcapsules. It is also possible, however, to use all of the fragrance in encapsulated or non-encapsulated form. The microcapsules may be water-soluble and/or water-insoluble microcapsules. Melamine/urea/formaldehyde microcapsules, melamine/formaldehyde microcapsules, urea/formaldehyde microcapsules or starch microcapsules may be used, for example. “Fragrance precursor” refers to compounds which only release the actual fragrance following chemical conversion/separation, typically when exposed to light or other environmental conditions, such as pH, temperature, etc. Compounds of this kind are often referred to as pro-fragrances.

Irrespective of the form in which they are used, the amount of fragrance in the composition is preferably between 1 and 20 wt. %, preferably from 1 to 15 wt. %, in particular from 3 to 12 wt. %, based on the total weight of the composition. One feature of the present invention is that the fragrance or the fragrance particles is/are uniformly distributed in the carrier material and in particular is/are not in the form of a coating on a core made of carrier material.

In various embodiments, the composition according to the invention does not contain, in the form of a coating, any polyethylene glycol (PEG) that is solid at room temperature (25° C.); preferably, the composition overall does not contain PEG that is solid at room temperature (25° C.), i.e. the content of PEG that is solid at room temperature (25° C.) is less than 1 wt. %, based on the composition.

In further embodiments, the composition according to the invention does not contain, in the form of a coating, any polyethylene glycol (PEG) at all; preferably, the composition overall does not contain any PEG at all, i.e. the content of PEG that is either solid or liquid at room temperature is less than 1 wt. %, based on the composition.

The composition further contains at least one buffer system as defined above. The buffer system is preferably solid, i.e. is a solid (mixture) under standard conditions. The term “buffer capacity” refers here to the amount of hydrochloric acid (HCl) in mg that is necessary to lower the pH of a solution of 1 g of the solid composition in 50 g of deionized water under standard conditions (20° C., 1,013 mbar) to less than 6.75. The buffer systems used according to the invention are preferably distinguished in that they have a pKa of at least 5.75, preferably at least 6.25, more preferably at least 6.75, and preferably no more than 12, more preferably less than 11.5, even more preferably 11 or less, most preferably 10.5 or less. Without being limited hereto, suitable buffer systems are, for example, sodium hydrogen carbonate, sodium carbonate, disodium hydrogen phosphate, sodium glutamate, sodium aspartate, tris(hydroxymethyl)aminomethane (TRIS) and further organic and inorganic buffer substances that are known in the prior art and meet the above criteria, and mixtures of the above. TRIS is particularly preferred.

The buffer substances are used in the compositions according to the invention, for example, in amounts of from 0.1 to 10 wt. %, preferably from 0.5 to 7.5 wt. %, more preferably from 1 to 5 wt. %, in each case based on the total weight of the composition, and are preferably selected from sodium hydrogen carbonate, sodium carbonate, disodium hydrogen phosphate, sodium glutamate, sodium aspartate, tris(hydroxymethyl)aminomethane (TRIS) and combinations thereof.

The composition may further contain an inorganic substance, preferably pyrogenic silica, to adjust the viscosity/rheological properties of the melt. Said substance is preferably contained in the composition in an amount of from 0.1 to 20 wt. %, preferably from 0.5 to 3 wt. %, more preferably from 1 to 2.5 wt. %, even more preferably from 1.2 to 2.0 wt. %. The used silicas are preferably highly dispersed silicas, e.g. those having BET surfaces areas of more than 50 m²/g, preferably more than 100 m²/g, more preferably from 150 to 250 m²/g, in particular from 175 to 225 m²/g.

Suitable silicas are commercially available from Evonik under the trade names Aerosil® and Sipernat®. Aerosil® 200 is particularly preferred.

In various embodiments, the composition may additionally or alternatively contain further ingredients that are liquid or solid (at 20° C. and 1 bar) and can be used to adjust desired properties of the composition. Properties of this kind may also be the viscosity or the rheological properties of the melt. Substances of this kind are, for example, organic rheology modifiers, preferably cellulose, in particular microfibrillated cellulose (MFC, nanocellulose). In particular, MFCs that are commercially available, for example, as Exilva (Borregaard) or Avicel® (FMC) are suitable as cellulose. In addition or as an alternative to the above-mentioned substances, further solids or fillers that differ from the above may also be contained.

Microfibrillated cellulose (MFC) is preferably used in amounts of up to 5 wt. %, particularly preferably from 0.1 to 3 wt. %, more preferably from 0.3 to 2 wt. %, in each case based on the total weight of the composition.

Furthermore, suitable ingredients are also emulsifying substances, such as fatty alcohols, e.g. stearyl alcohol, fatty alcohol alkoxylates, e.g. fatty alcohol alkoxylates used as non-ionic surfactants, fatty alcohol and fatty alcohol ether sulfates and alkyl benzene sulfonates, in particular those that are also used as anionic surfactants. Suitable fatty alcohol ethoxylates are in particular C10-22 fatty alcohol ethoxylates having up to 50 EO, very particularly preferably C12-18 alkyl ethers having 5-8, preferably 7 EO, or C16-18 alkyl ethers having up to 30 EO. Suitable fatty alcohol ether sulfates are the sulfates of the above-mentioned fatty alcohol ethers; suitable fatty alcohol sulfates are in particular C10-18 fatty alcohol sulfates, very particularly C12-16 fatty alcohol sulfates. Suitable alkyl benzene sulfonates are in particular linear C10-13 alkyl benzene sulfonates. To summarize, emulsifiers from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof are preferred.

The composition may contain further solids or fillers (f) that are different from components (a) to (f). The percentage by weight of said solids or fillers in the total weight of the composition is, for example, up to 25 wt. %, preferably up to 20 wt. %, more preferably up to 18 wt. %, in particular up to 15 wt. %, based on the total weight of the composition.

The composition according to the claims, characterized in that components (c), (d), (e), (f) and (g) together are contained in said composition in amounts of from 0 to 25 wt. %, preferably from 1 to 20 wt. %, more preferably from 2 to 18 wt. %, in particular from 3 to 15 wt. %, based on the total weight of the composition.

Said composition may be dyed using suitable dyes to improve the aesthetics of the composition. Preferred dyes, which a person skilled in the art will have no difficulty in selecting, should be highly stable in storage, should not be sensitive to light and the other ingredients in the washing or cleaning agent, and should not be markedly substantive to textile fibers so as not to stain said textile fibers. Dyes of this kind are known in the prior art and are typically used in concentrations of from 0.001 to 0.5 wt. %, preferably from 0.01 to 0.3 wt. %.

As has already been described above, the composition may optionally also contain free water. The expression “free water”, as used herein, refers to water that is not bound as water of crystallization in a salt contained in the composition.

A composition as described herein can be used, for example, in the washing cycle of a laundry cleaning method and can thus transport the perfume to the laundry right at the start of the washing method. Furthermore, the composition according to the invention is easier and better to handle than liquid compositions because no drops are left on the rim of the bottle; these drops travel to edges on the base or lead to unsightly deposits in the region of the closure when the bottle is subsequently stored. The same applies to the situation where some of the composition is accidentally spilled when it is metered. It is also easier to remove the spilled amount, and with a cleaner result. A method for treating textiles, during which a composition according to the invention is metered into the washing liquor of a textile washing machine, is a further subject of this application.

The composition may optionally contain further typical ingredients, for example those that improve the application-specific and/or aesthetic properties.

Example formulations for suitable compositions include the following ingredients:
from 1 to 15, in particular from 2 to 8 wt. % perfume oil and/or fragrance capsules
from 0.00 to <1 wt. % dye(s)
from 1.0 to 2.5, in particular from 1.2 to 2.0 wt. % pyrogenic silica (BET 175-225) or from 0.1 to 3.0, in particular from 0.1 to 2 wt. % microfibrillated cellulose
from 0.1 to 10 wt. %, in particular from 0.5 to 7.5 wt. % of a buffer system, in particular TRIS
ad 100 wt. % carrier material, as defined herein, in particular sodium acetate trihydrate.

The composition of a number of preferred compositions can be found in the following tables (figures given in wt. % are based on the total weight of the agent, unless indicated otherwise). TRIS is preferably used as the buffer system.

| | Formula 1 | Formula 2 | Formula 3 | Formula 4 | Formula 5 |
|---|---|---|---|---|---|
| Sodium acetate trihydrate | 20 to 95 | 30 to 95 | 30 to 95 | 40 to 90 | 45 to 90 |
| Fragrance | 0.1 to 20 | 0.1 to 20 | 1.0 to 15 | 1.0 to 15 | 3.0 to 12 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 6 | Formula 7 | Formula 8 | Formula 9 | Formula 10 |
|---|---|---|---|---|---|
| Sodium acetate trihydrate | 20 to 95 | 30 to 95 | 30 to 95 | 40 to 90 | 45 to 90 |
| Perfume oil | 0.1 to 20 | 0.1 to 20 | 1.0 to 15 | 1.0 to 15 | 3.0 to 12 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 11 | Formula 12 | Formula 13 | Formula 14 | Formula 15 |
|---|---|---|---|---|---|
| Sodium acetate trihydrate | 20 to 95 | 30 to 95 | 30 to 95 | 40 to 90 | 45 to 90 |
| Fragrance capsules | 0.1 to 20 | 0.1 to 20 | 1.0 to 15 | 1.0 to 15 | 3.0 to 12 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 16 | Formula 17 | Formula 18 | Formula 19 | Formula 20 |
|---|---|---|---|---|---|
| Sodium acetate trihydrate | 20 to 95 | 30 to 95 | 30 to 95 | 40 to 90 | 45 to 90 |
| Perfume oil and fragrance capsules | 0.1 to 20 | 0.1 to 20 | 1.0 to 15 | 1.0 to 15 | 3.0 to 12 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 21 | Formula 22 | Formula 23 | Formula 24 | Formula 25 |
|---|---|---|---|---|---|
| Sodium acetate trihydrate | 20 to 95 | 30 to 95 | 30 to 95 | 40 to 90 | 45 to 90 |
| Fragrance | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 26 | Formula 27 | Formula 28 | Formula 29 | Formula 30 |
|---|---|---|---|---|---|
| Sodium acetate trihydrate | 20 to 95 | 30 to 95 | 30 to 95 | 40 to 90 | 45 to 90 |
| Perfume oil | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 31 | Formula 32 | Formula 33 | Formula 34 | Formula 35 |
|---|---|---|---|---|---|
| Sodium acetate trihydrate | 20 to 95 | 30 to 95 | 30 to 95 | 40 to 90 | 45 to 90 |
| Fragrance capsules | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 36 | Formula 37 | Formula 38 | Formula 39 | Formula 40 |
|---|---|---|---|---|---|
| Sodium acetate trihydrate | 20 to 95 | 30 to 95 | 30 to 95 | 40 to 90 | 45 to 90 |
| Perfume oil and fragrance capsules | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 41 | Formula 42 | Formula 43 | Formula 44 | Formula 45 |
|---|---|---|---|---|---|
| Sodium acetate trihydrate | 20 to 95 | 30 to 95 | 30 to 95 | 40 to 90 | 45 to 90 |
| Fragrance | 0.1 to 20 | 0.1 to 20 | 1.0 to 15 | 1.0 to 15 | 3.0 to 12 |
| (Microfibrillated) cellulose | 0.1 to 25 | 0.1 to 20 | 0.1 to 18 | 0.1 to 15 | 0.1 to 10 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 46 | Formula 47 | Formula 48 | Formula 49 | Formula 50 |
|---|---|---|---|---|---|
| Sodium acetate trihydrate | 20 to 95 | 30 to 95 | 30 to 95 | 40 to 90 | 45 to 90 |
| Perfume oil | 0.1 to 20 | 0.1 to 20 | 1.0 to 15 | 1.0 to 15 | 3.0 to 12 |
| (Microfibrillated) cellulose | 0.1 to 25 | 0.1 to 20 | 0.1 to 18 | 0.1 to 15 | 0.1 to 10 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 51 | Formula 52 | Formula 53 | Formula 54 | Formula 55 |
|---|---|---|---|---|---|
| Sodium acetate trihydrate | 20 to 95 | 30 to 95 | 30 to 95 | 40 to 90 | 45 to 90 |
| Fragrance capsules | 0.1 to 20 | 0.1 to 20 | 1.0 to 15 | 1.0 to 15 | 3.0 to 12 |
| (Microfibrillated) cellulose | 0.1 to 25 | 0.1 to 20 | 0.1 to 18 | 0.1 to 15 | 0.1 to 10 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 56 | Formula 57 | Formula 58 | Formula 59 | Formula 60 |
|---|---|---|---|---|---|
| Sodium acetate trihydrate | 20 to 95 | 30 to 95 | 30 to 95 | 40 to 90 | 45 to 90 |
| Perfume oil and fragrance capsules | 0.1 to 20 | 0.1 to 20 | 1.0 to 15 | 1.0 to 15 | 3.0 to 12 |
| (Microfibrillated) cellulose | 0.1 to 25 | 0.1 to 20 | 0.1 to 18 | 0.1 to 15 | 0.1 to 10 |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 61 | Formula 62 | Formula 63 | Formula 64 | Formula 65 |
|---|---|---|---|---|---|
| Sodium acetate trihydrate | 20 to 95 | 30 to 95 | 30 to 95 | 40 to 90 | 45 to 90 |
| Fragrance | 0.1 to 20 | 0.1 to 20 | 1.0 to 15 | 1.0 to 15 | 3.0 to 12 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 66 | Formula 67 | Formula 68 | Formula 69 | Formula 70 |
|---|---|---|---|---|---|
| Sodium acetate trihydrate | 20 to 95 | 30 to 95 | 30 to 95 | 40 to 90 | 45 to 90 |
| Perfume oil | 0.1 to 20 | 0.1 to 20 | 1.0 to 15 | 1.0 to 15 | 3.0 to 12 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 71 | Formula 72 | Formula 73 | Formula 74 | Formula 75 |
|---|---|---|---|---|---|
| Sodium acetate trihydrate | 20 to 95 | 30 to 95 | 30 to 95 | 40 to 90 | 45 to 90 |
| Fragrance capsules | 0.1 to 20 | 0.1 to 20 | 1.0 to 15 | 1.0 to 15 | 3.0 to 12 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 76 | Formula 77 | Formula 78 | Formula 79 | Formula 80 |
|---|---|---|---|---|---|
| Sodium acetate trihydrate | 20 to 95 | 30 to 95 | 30 to 95 | 40 to 90 | 45 to 90 |
| Perfume oil and fragrance capsules | 0.1 to 20 | 0.1 to 20 | 1.0 to 15 | 1.0 to 15 | 3.0 to 12 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 81 | Formula 82 | Formula 83 | Formula 84 | Formula 85 |
|---|---|---|---|---|---|
| Sodium acetate trihydrate | 20 to 95 | 30 to 95 | 30 to 95 | 40 to 90 | 45 to 90 |
| Fragrance | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| (Microfibrillated) cellulose | 0.1 to 25 | 0.1 to 20 | 0.1 to 18 | 0.1 to 15 | 0.1 to 10 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 86 | Formula 87 | Formula 88 | Formula 89 | Formula 90 |
|---|---|---|---|---|---|
| Sodium acetate trihydrate | 20 to 95 | 30 to 95 | 30 to 95 | 40 to 90 | 45 to 90 |
| Perfume oil | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| (Microfibrillated) cellulose | 0.1 to 25 | 0.1 to 20 | 0.1 to 18 | 0.1 to 15 | 0.1 to 10 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 91 | Formula 92 | Formula 93 | Formula 94 | Formula 95 |
|---|---|---|---|---|---|
| Sodium acetate trihydrate | 20 to 95 | 30 to 95 | 30 to 95 | 40 to 90 | 45 to 90 |
| Fragrance capsules | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| (Microfibrillated) cellulose | 0.1 to 25 | 0.1 to 20 | 0.1 to 18 | 0.1 to 15 | 0.1 to 10 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

| | Formula 96 | Formula 97 | Formula 98 | Formula 99 | Formula 100 |
|---|---|---|---|---|---|
| Sodium acetate trihydrate | 20 to 95 | 30 to 95 | 30 to 95 | 40 to 90 | 45 to 90 |
| Perfume oil and fragrance capsules | 0.1 to 20 | 0.1 to 20 | 1.0 to 15 | 1.0 to 15 | 3.0 to 12 |
| Pyrogenic silica | 1.0 to 2.5 | 1.0 to 2.5 | 1.0 to 2.5 | 1.2 to 2.0 | 1.2 to 2.0 |
| (Microfibrillated) cellulose | 0.1 to 25 | 0.1 to 20 | 0.1 to 18 | 0.1 to 15 | 0.1 to 10 |
| Fatty alcohol ethoxylate having | 0.1 to 10 | 0.1 to 5.0 | 0.2 to 5.0 | 0.2 to 3.0 | 0.5 to 2.0 |
| from 5 to 50 EO | | | | | |
| Buffer system | 0.1 to 10 | 0.25 to 8.5 | 0.5 to 7.5 | 0.75 to 6.0 | 1.0 to 5.0 |
| Misc. | ad 100 | ad 100 | ad 100 | ad 100 | ad 100 |

The composition according to the present invention is a solid, particulate composition. The individual particles of the composition can be referred to as melt bodies that are solid at room temperature and at temperatures up to 30° C., preferably up to 40° C.

In various embodiments of the invention, the melt bodies according to the invention are coated. Tablet coatings known from the pharmaceutical literature, for example, are suitable as a coating agent. However, the tablets may also be waxed, i.e. coated in a wax, or powdered with a powdered material, such as a release agent, for protection from caking (agglomeration). It is preferred for the coating not to consist of PEG or to comprise it in a significant amount (>10 wt. % based on the coating).

A method for preparing melt bodies of this kind may comprise the following steps:
(a) producing, preferably continuously producing and conveying, a melt comprising the at least one water-soluble carrier material and the buffer system;
(b) optionally metering further optional ingredients;
(c) metering, preferably continuously metering, the at least one fragrance and optionally a dye into the melt;
(d) mixing the melt and the at least one fragrance; and
(e) cooling and optionally shaping the mixture to obtain perfume-containing melt bodies.

The thus prepared melt bodies can be of any desired shape. The shaping takes place in particular in step (d) of the described method. Solid, particulate shapes such as substantially spherical, figure-like, flake-shaped, cuboid, cylindrical, cone-shaped, spherical-cap-shaped or lens-shaped, hemispherical, disk-shaped or needle-shaped particles are preferred. For example, the particles may have a gummy-bear, figure-like design. On account of their manufacturing properties and their performance profile, hemispherical particles are particularly preferred.

In addition, it is preferred for the composition to consist, in a proportion of at least 20 wt. %, preferably at least 40 wt. %, particularly preferably at least 60 wt. % and very particularly preferably at least 80 wt. %, of particles which extend between 0.5 and 10 mm, in particular from 0.8 to 7 mm and particularly preferably from 1 to 3 mm in any spatial direction. Corresponding particles are distinguished by greater customer acceptance on account of their aesthetics.

Lastly, it has been shown to be advantageous for metering and the effect of fragrance for the composition to consist, in a proportion of at least 20 wt. %, preferably at least 40 wt. %, particularly preferably at least 60 wt. % and very particularly preferably at least 80 wt. %, of particles which have a particle weight of between 2 and 150 mg, preferably between 4 and 60 mg and in particular between 5 and 10 mg.

The above-described particularly preferred melt bodies, in particular those that have a particle weight of between 2 and 150 mg, extend between 0.5 and 10 mm and have a hemispherical shape can advantageously be prepared by means of pastillation.

Within the scope of a preferred method variant of this kind, the melt of the water-soluble carrier material is pressed into a heated inner body and a drum-shaped outer tube which is provided with a large number of holes and which rotates concentrically about the stationary inner body, thereby depositing product drops over the entire width of a continuous cooling belt, preferably a steel belt.

The viscosity (Texas Instruments AR-G2 Rheometer; plate/plate, 4 cm diameter, 1100 μm gap; shear rate 10/1 sec) of the mixture as it leaves the rotating, perforated outer drum is preferably between 1,000 and 10,000 mPas.

The drops of the mixture output from the drop former are solidified to form solid melt bodies on the steel belt. The period of time between the mixture being dropped onto the steel belt and the mixture completely solidifying is preferably between 5 and 60 seconds, particularly preferably between 10 and 50 seconds and in particular between 20 and 40 seconds.

The solidification of the mixture is preferably assisted and accelerated by cooling. The drops output onto the steel belt can be cooled either directly or indirectly. Cooling by means of cold air can be used, for example, as direct cooling. However, cooling the drops indirectly by cooling the underside of the steel belt by means of cold water is preferred.

A preferred method for preparing hemispherical melt bodies, in particular for preparing the melt bodies described in formulas 1 to 100 in terms of their composition, comprises the following steps:
(a) producing, preferably continuously producing and conveying, a melt comprising the at least one water-soluble carrier material and the buffer system;
(b) optionally metering further optional ingredients;
(c) metering, preferably continuously metering, the at least one fragrance, the at least one buffer system and optionally a dye into the melt;
(d) mixing the melt and the at least one fragrance;
(e) outputting drops of the resultant mixture onto a cooling belt by means of a drop former having a rotating, perforated outer drum; and
(f) solidifying the drops of the mixture on the steel belt so as to form solid hemispherical melt bodies.

A very particularly preferred method variant, in particular for preparing the melt bodies described in formulas 1 to 100 in terms of their composition, comprises the following steps:
(a) producing, preferably continuously producing and conveying, a melt comprising the at least one water-soluble carrier material sodium acetate trihydrate (Na(CH₃COO).3H₂O) and the buffer system;
(b) optionally metering further optional ingredients;
(c) metering, preferably continuously metering, the at least one fragrance, the at least one buffer system and optionally a dye into the melt;
(d) mixing the melt and the at least one fragrance;
(e) outputting drops of the resultant mixture onto a cooling belt by means of a drop former having a rotating, perforated outer drum; and
(f) solidifying the drops of the mixture on the steel belt so as to form solid hemispherical melt bodies.

In various embodiments, the production of a melt, i.e. the melting, takes place in step (a) of the method described herein by heating to a temperature of no more than 20° C. above the temperature of the carrier material at which the water vapor partial pressure of the hydrate corresponds to the H₂O partial pressure of the saturated solution of said salt. As has already been described above, the carrier material may be used as a ready-prepared hydrate or the hydrate is produced in situ prior to step (a) or in step (a) by combining the water-free salt and water in a substoichiometric, stoichiometric or hyperstoichiometric amount, preferably in a stoichiometric or hyperstoichiometric amount, based on the necessary amount for converting all of the salt to the desired hydrate.

The melting can take place by means of all typical methods and devices known to a person skilled in the art. The melt containing the at least one carrier material is, for example, continuously produced by continuously supplying the at least one carrier material, the bittern and optionally further optional components of the melt body, such as pyrogenic silica, the cellulose, the fatty alcohols, fatty alcohol alkoxylates, fatty alcohol sulfates, fatty alcohol ether sulfates, alkyl benzene sulfonates or a solid or filler in isolation or in combination to a corresponding device, in which the mixture is heated and the thus produced melt is conveyed, for example pumped.

The melt may also be prepared separately, for example in a batch process. According to the invention, embodiments are also included in which the components of the melt are mixed at any desired time before carrying out the method according to the invention and the mixture is stored in molten form or in cooled, solid form until the method is carried out. The thus produced melt can be used as a master batch to which different fragrances and optionally also further ingredients, such as dyes, are then metered as required in the following step.

In a subsequent step, the at least one fragrance is then continuously metered into the melt. For this purpose, the at least one fragrance is preferably used in liquid form, for example as a perfume oil, a solution in a suitable solvent or a dispersion of perfume capsules in a, typically aqueous, solvent. “Liquid”, as used in this context, refers to liquid under the used conditions, preferably liquid at 20° C. In addition to the fragrance, a dye may also be metered in this step. The dye may be indicative, for example, of the type of fragrance, i.e. a specific dye or dye mixture is used for a particular fragrance/fragrance mixture to make it possible to immediately visually distinguish the obtained tablets.

During preparation, the rate of flow may optionally be controlled by measuring the rate of flow of the individual metered flows, i.e. the melt, the flow of fragrance and the flow of optionally further ingredients. This makes it possible to also adjust, for example, the amount ratios of the individual components. The ingredients other than the carrier material and the fragrances may be directly produced as a melt together with the carrier material or metered together with the fragrances or separately from the melt. In the case of the latter alternative, the metering may take place before or after the fragrances are metered.

In some embodiments, the method according to the invention is characterized in that the at least one buffer system and optionally at least one further component of the melt body, such as the pyrogenic silica, the cellulose, the fatty alcohols, fatty alcohol alkoxylates, fatty alcohol sulfates, fatty alcohol ether sulfates, alkyl benzene sulfonates or a solid or filler, are metered in isolation or in combination into the melt that is produced and conveyed in step (a) and/or are contained in the melt that is produced and conveyed in step (a).

Either immediately after being metered or further downstream after a plurality or all of the ingredients have been metered, the combined metered flows can then be mixed by means of suitable mixers, such as common static or dynamic mixing units.

Following mixing, the melt that contains the fragrance, the buffer system and optionally solids and optionally further ingredients and the carrier material is cooled and optionally shaped, the melt solidifying and adopting its final shape in this process. Suitable shaping methods are known to a person skilled in the art. Common shapes have already been described above.

The invention also relates to the melt bodies that can be obtained by means of the methods described herein and to the use thereof as textile care agents, preferably fragrancing agents for fragrancing textile fabrics. The melt bodies may be a textile treatment agent, such as a softener, or part of an agent of this kind.

The invention further relates to a washing or cleaning agent, comprising the melt bodies prepared according to the invention.

By introducing the perfume-containing melt bodies prepared according to the invention into a washing or cleaning agent, the consumer is provided with a textile-maintaining washing or cleaning agent (“2-in-1” washing or cleaning agent) and does not have to meter two agents or require a separate rinsing cycle. Since the compositions prepared according to the invention are perfumed, the washing or cleaning agent does not have to be perfumed either. This not only leads to lower costs, but is also advantageous for consumers having sensitive skin and/or allergies.

The melt body compositions described herein are suitable in particular for fragrancing textile fabrics; for this purpose, said compositions, together with a conventional washing or cleaning agent, are brought into contact with the textile fabrics in the (main) washing cycle of a conventional washing and cleaning process.

If the melt body composition according to the invention is part of a washing or cleaning agent, a solid washing or cleaning agent may be mixed with preferably from 1 to 20 wt. %, in particular from 5 to 15 wt. %, of the composition according to the invention.

The preferred embodiments described in connection with the methods according to the invention can also be carried over to the melt bodies as such, the washing and cleaning agents containing said bodies and the uses described herein, and vice versa.

In summary, the present invention provides, inter alia:
1. A solid, particulate composition comprising
   (a) from 20 to 95 wt. %, based on the total weight of the composition, of at least one water-soluble carrier material selected from aqueous salts of which the water vapor partial pressure at a particular temperature in the range of from 30 to 100° C. corresponds to the H₂O partial pressure of the saturated solution of said salt;
   (b) from 0.1 to 20 wt. % of at least one fragrance;
   (c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, of at least one solid or filler that is different from (c), (d), (e) and (f); and
   (i) optionally at least one dye.
2. A solid, particulate composition comprising
   (a) from 20 to 95 wt. %, based on the total weight of the composition, of at least one water-soluble carrier material selected from aqueous salts of which the water vapor partial pressure at a particular temperature in the range of from 30 to 100° C. corresponds to the H₂O partial pressure of the saturated solution of said salt;
   (b) from 0.1 to 20 wt. % of at least one fragrance;
   (c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, of at least one solid or filler that is different from (c), (d), (e) and (f); and
   (i) optionally at least one dye.
3. The composition according to one of points 1 or 2, characterized in that the water-soluble carrier material is selected from aqueous salts of which the water vapor partial pressure at a particular temperature in the range of from 40 to 90° C., preferably from 50 to 85° C., more preferably from 55 to 80° C., corresponds to the H₂O partial pressure of the saturated solution of said salt, and is preferably sodium acetate trihydrate (Na(CH₃COO).3H₂O).
4. The composition according to one of points 1 to 3, characterized in that the water-soluble carrier material is contained in said composition in an amount of from 30 to 95 wt. %, preferably from 40 to 90 wt. %, in particular from 45 to 90 wt. %, based on the total weight of the composition.
5. A solid, particulate composition comprising
   (a) from 12 to 57 wt. %, based on the total weight of the composition, sodium acetate;
   (b) from 0.1 to 10 wt. % of at least one fragrance;
   (c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, of at least one solid or filler that is different from (c), (d), (e) and (f);
   (h) optionally at least one dye; and
   (i) water in an amount that is sufficient to convert at least 60 wt. %, preferably at least 70 wt. %, more preferably at least 80 wt. %, most preferably at least 100 wt. % of the sodium acetate (a) into sodium acetate trihydrate.
6. A solid, particulate composition, comprising
   (a) from 12 to 57 wt. %, based on the total weight of the composition, sodium acetate;
   (b) from 0.1 to 10 wt. % of at least one fragrance;
   (c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, of at least one solid or filler that is different from (c), (d), (e) and (f);
   (h) optionally at least one dye; and
   (i) water in an amount that is sufficient to convert at least 60 wt. %, preferably at least 70 wt. %, more preferably at least 80 wt. %, most preferably at least 100 wt. % of the sodium acetate (a) into sodium acetate trihydrate.
7. The composition according to one of points 5 or 6, characterized in that the sodium acetate is contained in said composition in an amount of from 18 to 57 wt. %, preferably from 24 to 48 wt. %, in particular from 27 to 45 wt. %, based on the total weight of the composition.
8. A solid, particulate composition comprising
   (a) from 20 to 95 wt. %, based on the total weight of the composition, sodium acetate trihydrate;
   (b) from 0.1 to 10 wt. % of at least one fragrance;
   (c) at least one buffer system, preferably a solid buffer system, of such a type and in such an amount that, when 1 g of the composition is dissolved in 50 g of deionized water, a pH of 12, preferably 11.5, more preferably 11, is not exceeded and the buffer capacity of the resultant solution is at least 2 mg HCl/g of the composition, preferably at least 3 mg HCl/g of the composition, more preferably at least 4 mg HCl/g of the composition;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, of at least one solid or filler that is different from (c), (d), (e) and (f); and
   (h) optionally at least one dye.
9. A solid, particulate composition, comprising
   (a) from 20 to 95 wt. %, based on the total weight of the composition, sodium acetate trihydrate;
   (b) from 0.1 to 10 wt. % of at least one fragrance;
   (c) from 0.1 to 10 wt. %, preferably from 0.5 to 7.5 wt. %, more preferably from 1 to 5 wt. % of at least one buffer system, preferably a solid buffer system selected from the group consisting of sodium hydrogen carbonate, sodium carbonate, disodium hydrogen phosphate, sodium glutamate, sodium aspartate, tris(hydroxymethyl)aminomethane (TRIS) and combinations thereof, preferably TRIS;
   (d) optionally up to 25 wt. %, preferably from 0.5 to 3 wt. %, based on the total weight of the composition, of an inorganic rheology modifier, preferably an inorganic rheology modifier from the group of pyrogenic silicas;
   (e) optionally up to 25 wt. %, preferably from 0.5 to 3 wt. %, based on the total weight of the composition, of an organic rheology modifier, preferably an organic rheology modifier from the group of celluloses, preferably microfibrillated celluloses;
   (f) optionally up to 25 wt. %, based on the total weight of the composition, of an emulsifier, preferably an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
   (g) optionally up to 25 wt. %, based on the total weight of the composition, at least one solid or filler that is different from (c), (d), (e) and (f); and
   (h) optionally at least one dye.
10. The composition according to one of points 8 or 9, characterized in that the sodium acetate trihydrate is contained in said composition in an amount of from 30 to 95 wt. %, preferably from 40 to 90 wt. %, in particular from 45 to 90 wt. %, based on the total weight of the composition.
11. The composition according to one of the preceding points, characterized in that the at least one fragrance is contained in the composition in an amount of from 1 to 20 wt. %, preferably from 1 to 15 wt. %, more preferably from 3 to 12 wt. %.
12. The composition according to one of the preceding points, characterized in that the at least one fragrance is used in the form of fragrance capsules and/or perfume oils.
13. The composition according to one of the preceding points, characterized in that the inorganic rheology modifier, in particular the pyrogenic silica, based on the total weight of the composition, is contained in the composition in an amount of from 1 to 2.5 wt. %, preferably from 1.2 to 2.0 wt. %.
14. The composition according to one of the preceding points, characterized in that the pyrogenic silica has a BET surface area of more than 50 m²/g, preferably more than 100 m²/g, more preferably from 150 to 250 m²/g, in particular from 175 to 225 m²/g.
15. The composition according to one of the preceding points, characterized in that the organic rheology modifier, in particular the cellulose, preferably the microfibrillated cellulose, based on the total weight of the composition, is contained in the composition in an amount of from 1 to 2.5 wt. %, preferably from 1.2 to 2.0 wt. %.
16. The composition according to one of the preceding points, characterized in that components (d), (e) and (f), independently of one another, are contained in said composition in amounts of from 0 to 25 wt. %, preferably up to 20 wt. %, more preferably up to 18 wt. %, in particular up to 15 wt. %, based on the total weight of the composition.
17. The composition according to one of the preceding points, characterized in that the composition further contains at least one dye, preferably in a concentration of from 0.001 to 0.5 wt. %, particularly preferably from 0.01 to 0.3 wt. %, based on the total weight of the composition.
18. The composition according to one of the preceding points, characterized in that the composition does not contain, in the form of a coating, polyethylene glycol that is solid at room temperature (25° C.).
19. The composition according to one of the preceding points, characterized in that the composition contains less than 1 wt. %, based on the total weight, polyethylene glycol that is solid at room temperature (25° C.).
20. The composition according to one of the preceding points, characterized in that the composition further contains free water.
21. The composition according to one of the preceding points, characterized in that the composition is in the form of hemispherical particles.
22. The composition according to one of the preceding points, characterized in that the composition consists, in a proportion of at least 20 wt. %, preferably at least 40 wt. %, particularly preferably at least 60 wt. % and very particularly preferably at least 80 wt. %, of particles which extend between 0.5 and 10 mm, in particular from 0.8 to 7 mm and particularly preferably from 1 to 3 mm in any spatial direction.
23. The composition according to one of the preceding points, characterized in that the composition consists, in a proportion of at least 20 wt. %, preferably at least 40 wt. %, particularly preferably at least 60 wt. % and very particularly preferably at least 80 wt. %, of particles which have a particle weight of between 2 and 150 mg, preferably between 4 and 60 mg and in particular between 5 and 10 mg.
24. The use of the solid composition according to one of points 1 to 23 as a textile care agent for fragrancing textile fabrics.
25. A washing or cleaning agent, comprising a solid composition according to one of points 1 to 23.
26. A method for preparing the composition according to one of points 1 to 23, comprising
   (a) producing a melt comprising the at least one water-soluble carrier material;
   (b) optionally metering further optional ingredients;
   (c) metering the at least one fragrance, the at least one bittern and optionally a dye into the melt;
   (d) mixing the melt and the at least one fragrance; and
   (e) cooling and optionally shaping the mixture to obtain perfume-containing melt bodies.
27. A method for preparing the composition according to one of points 1 to 23, comprising
   (a) producing, preferably continuously producing and conveying, a melt comprising the at least one water-soluble carrier material and the buffer system;
   (b) optionally metering further optional ingredients;
   (c) metering, preferably continuously metering, the at least one fragrance, the at least one buffer system and optionally a dye into the melt;
   (d) mixing the melt and the at least one fragrance;
   (e) outputting drops of the resultant mixture onto a cooling belt by means of a drop former having a rotating, perforated outer drum; and
   (f) solidifying the drops of the mixture on the steel belt so as to form solid melt bodies.
28. A method for treating textiles, during which a composition according to one of points 1 to 23 is metered into the washing liquor of a textile washing machine.

### EXAMPLES

### Example 1

The following table contains an example of a formulation according to the invention (all figures given in wt. %).

TABLE 1
Compositions

| | | |
|---|---|---|
| Sodium acetate trihydrate | 84.70 | |
| Sodium acetate trihydrate | | 56.0 |
| (water-free) | | |
| Hydrophilic pyrogenic silica | 1.50 | |
| (Aerosil 200) | | |
| C16/18 fatty alcohol 30 EO | 0.80 | |
| Microfibrillated cellulose (2% in water) | | 29.2 |
| Perfume | 4.5 | 0.9 |
| Perfume capsule slurry (50%) | 5.5 | 5.8 |
| Buffer system, preferably TRIS | 0-5 (variable) | 0-5 (variable) |
| Dye | | 0.1% |
| Water | ad 100 | ad 100 |

For the preparation, the sodium acetate trihydrate was heated to a temperature of 70° C. and largely dissolved in the separated water of crystallization thereof while being stirred. The other components were subsequently incorporated. When water-free acetate was used, the solution was prepared by stirring the acetate with the water from the formulation and the microfibrillar cellulose, which contains 98% water, at 70° C. Tablets were prepared by dropping the liquid mixture (“melt”) onto a cooling plate of which the temperature was adjusted to room temperature (23° C.).

The thus prepared fragrance tablets according to the invention were then tested for their buffer capacity by dissolving 1 g of the tablets in 50 mL of deionized water in a 400 mL beaker while stirring using a magnetic stirrer at 300 rpm and 20° C., and titrating the solution with HCl (aq) until a pH of 6.75 was reached. The obtained buffer capacities are indicated in Table 2.

TABLE 2
Buffer capacity

| | mg (HCl) |
|---|---|
| 1 g of tablets | 1.77 |
| +1% TRIS | 4.55 |
| +2% TRIS | 6.72 |
| +5% TRIS | 16.1 |
| +1% Na₂CO₃ | 5.75 |
| +5% Na₂CO₃ | 21.79 |

What is claimed is:

1. A solid, particulate composition comprising
(a) from 20 to 95 wt. %, based on the total weight of the composition, of at least one water-soluble carrier material selected from aqueous salts of which the water vapor partial pressure at a temperature in the range of from 30 to 100° C. corresponds to the H₂O partial pressure of the saturated solution of said salt at said temperature;
(b) from 0.1 to 20 wt. % of at least one fragrance;
(c) at least one buffer system of such a type and in such an amount that, when 1 g of the composition is dissolved in 50 g of deionized water, a pH of 12 is not exceeded and the buffer capacity of the resultant solution is at least 2 mg HCl/g of the composition;
(d) up to 25 wt. % based on the total weight of the composition, of an inorganic rheology modifier;
(e) up to 25 wt. %, based on the total weight of the composition, of an organic rheology modifier;
(f) up to 25 wt. % of an emulsifier;
(g) up to 25 wt. %, based on the total weight of the composition, of at least one solid or filler that is different from (c), (d) and (e);
(h) at least one dye.

2. The composition according to claim 1, characterized in that the water-soluble carrier material
(A) is selected from aqueous salts of which the water vapor partial pressure at a temperature in the range from 40 to 90° C. corresponds to the H₂O partial pressure of the saturated solution of said salt; and
(B) is contained in said composition in an amount from 30 to 95 wt. % based on the total weight of the composition.

3. The composition according to claim 1, characterized in that the at least one fragrance
(A) is contained in the composition in an amount from 1 to 20 wt. %; and
(B) is used in the form of fragrance capsules or perfume oils.

4. The composition according to claim 1, characterized in that the at least one buffer system
(A) is contained in the composition in an amount from 0.1 to 10 wt. %; and
(B) is selected from the group consisting of sodium hydrogen carbonate, sodium carbonate, disodium hydrogen phosphate, sodium glutamate, sodium aspartate, tris(hydroxymethyl)aminomethane (TRIS) and combinations thereof.

5. The composition according to claim 1, characterized in that pyrogenic silica
(A) is contained in the composition in an amount from 1 to 2.5 wt. %; and
(B) has a BET surface area of more than 50 m²/g.

6. The composition according to claim 1, characterized in that the composition further contains at least one dye based on the total weight of the composition.

7. The composition according to claim 1, characterized in that the composition further contains free water.

8. A method for preparing the composition according to claim 1, comprising:
(a) producing a melt comprising the at least one water-soluble carrier material;
(b) metering further optional ingredients;
(c) metering the at least one fragrance, at least one buffer system and a dye into the melt;
(d) mixing the melt and the at least one fragrance; and
(e) cooling and shaping the mixture to obtain perfume-containing melt bodies.

9. The use of the solid composition according to claim 1 as a textile care agent for fragrancing textile fabrics.

10. A washing or cleaning agent, comprising a solid composition according to claim 1.

11. The composition, according to claim 1, comprising
(a) from 20 to 95 wt. %, based on the total weight of the composition, of at least one water-soluble carrier material selected from aqueous salts of which the water vapor partial pressure at a temperature in the range of from 30 to 100° C. corresponds to the H₂O partial pressure of the saturated solution of said salt at said temperature;
(b) from 0.1 to 20 wt. % of at least one fragrance;
(c) at least a solid buffer system of such a type and in such an amount that, when 1 g of the composition is dissolved in 50 g of deionized water, a pH of 11.5 is not exceeded and the buffer capacity of the resultant solution is at least 3 mg HCl/g of the composition;
(d) from 0.5 to 3 wt. % based on the total weight of the composition, of an inorganic rheology modifier from the group of pyrogenic silicas;
(e) from 0.5 to 3 wt. % based on the total weight of the composition, of an organic rheology modifier from the group of celluloses;
(f) up to 25 wt. % of an emulsifier from the group of fatty alcohols, fatty alcohol alkoxylates, fatty amide ethoxylates, fatty alcohol sulfates, fatty alcohol ether sulfates, alkyl benzene sulfonates, allyl polyglycosides, fatty acid sorbitan esters, alkylamine oxides, alkyl betaines or combinations thereof;
(g) up to 25 wt. %, based on the total weight of the composition, of at least one solid or filler that is different from (c), (d) and (e);
(h) at least one dye.

12. The composition, according to claim 1, comprising at least one buffer system of such a type and in such an amount that, when 1 g of the composition is dissolved in 50 g of deionized water, a pH of 11 is not exceeded and the buffer capacity of the resultant solution is at least 4 mg HCl/g of the composition.

13. The composition according to claim 2, characterized in that the water-soluble carrier material
(A) is selected from aqueous salts of which the water vapor partial pressure at a temperature in the range from 50 to 85° C. corresponds to the H₂O partial pressure of the saturated solution of said salt; and
(B) is contained in said composition in an amount from 40 to 90 wt. % based on the total weight of the composition.

14. The composition according to claim 2, characterized in that the water-soluble carrier material
(A) is selected from aqueous salts of which the water vapor partial pressure at a temperature in the range from 55 to 80° C. corresponds to the H₂O partial pressure of the saturated solution of said salt; and
(B) is contained in said composition in an amount from 45 to 90 wt. % based on the total weight of the composition.
